(19) United States
(12) Patent Application Publication
(10) Pub. No.: US 2024/0232335 A1
(43) Pub. Date: Jul. 11, 2024

(54) MODEL DETERMINATION APPARATUS AND METHOD

(71) Applicants: HON HAI PRECISION INDUSTRY CO., LTD., New Taipei City (TW); Foxconn Technology Group Co., Ltd., Guangdong Province (CN)

(72) Inventors: Nien-Yi JAN, New Taipei City (TW); Ting-Hsuan LEE, New Taipei City (TW); Yen-Cheng LIN, New Taipei City (TW); Yung-Hui LI, New Taipei City (TW); Wei-Bin LEE, New Taipei City (TW); Yu-Tou HSIEH, New Taipei City (TW)

(21) Appl. No.: 18/408,599

(22) Filed: Jan. 10, 2024

Related U.S. Application Data
(60) Provisional application No. 63/479,355, filed on Jan. 11, 2023.

(51) Int. Cl. G06F 21/55

(52) U.S. Cl. CPC G06F 21/55

(57) ABSTRACT

A model determination apparatus is configured to execute the following operations. Multiple candidate models are validated based on first adversarial validation data to generate a first accuracy corresponding to each of the candidate models, wherein the first adversarial validation data is generated by a first adversarial attack adjustment performed on validation data based on an initial model. A second adversarial attack adjustment is performed on the validation data based on each of the candidate models to generate a plurality of second adversarial validation data corresponding to each of the candidate models respectively. The candidate models are validated based on the corresponding second adversarial validation data to generate a second accuracy corresponding to each of the candidate models. At least one output model is selected from the candidate models based on the first accuracy and the second accuracy corresponding to each of the candidate models.

### CROSS-REFERENCE TO RELATED APPLICATION

This application claims priority to U.S. Provisional Application Ser. No. 63/479,355, filed Jan. 11, 2023, which is herein incorporated by reference in its entirety.

### BACKGROUND

### Field of Invention

The present disclosure relates to a model determination apparatus and method. More particularly, the present disclosure relates to a model determination apparatus and method for adversarial attacks.

### Description of Related Art

When a machine learning model is subjected to an adversarial attack, the model is prone to misjudgment, thereby posing risks to subsequent analysis. For example, if the input image of the driving recognition model in a self-driving car is subjected to an adversarial attack, it may cause the self-driving car to misjudge the road conditions and adopt the wrong driving strategies.

Although the existing defense technology against adversarial attacks can improve the recognition accuracy of input data against adversarial attacks, it will also affect the recognition accuracy of general input data, causing the overall recognition accuracy of the model to decrease.

On the other hand, when multiple candidate models need to be evaluated during the model training process, the prior art lacks of evaluation methods for the ability of the candidate models to defend against adversarial attacks. Therefore, it is difficult to select trustworthy models with higher accuracy based on their ability to defend against adversarial attacks.

In view of this, how to train a model with adversarial attack defense capabilities without sacrificing the overall recognition accuracy of the model and evaluate the ability of the candidate models to defend against adversarial attacks is the goal that the industry strives to work on.

### SUMMARY

The disclosure provides a model determination apparatus comprising a storage and a processor. The storage is configured to store a plurality of training data and a plurality of validation data. The processor is coupled to the storage and is configured to execute the following operations: validating a plurality of candidate models based on a plurality of first adversarial validation data to generate a first accuracy corresponding to each of the candidate models, wherein the first adversarial validation data is generated by a first adversarial attack adjustment performed on the validation data based on an initial model; performing a second adversarial attack adjustment on the validation data based on each of the candidate models to generate a plurality of second adversarial validation data corresponding to each of the candidate models respectively; validating the candidate models based on the corresponding second adversarial validation data to generate a second accuracy corresponding to each of the candidate models; and selecting at least one output model from the candidate models based on the first accuracy and the second accuracy corresponding to each of the candidate models.

The disclosure also provides a model determination method being adapted for use in a processor. The model determination method comprises: validating a plurality of candidate models based on a plurality of first adversarial validation data to generate a first accuracy corresponding to each of a plurality of candidate models, wherein the first adversarial validation data is generated by a first adversarial attack adjustment performed on a plurality of validation data based on an initial model; performing a second adversarial attack adjustment on the validation data based on each of the candidate models to generate a plurality of second adversarial validation data corresponding to each of the candidate models respectively; validating the candidate models based on the corresponding second adversarial validation data to generate a second accuracy corresponding to each of the candidate models; and selecting at least one output model from the candidate models based on the first accuracy and the second accuracy corresponding to each of the candidate models.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a model determination apparatus according to a first embodiment of the present disclosure.

FIG. 2 is a flow diagram illustrating the model determination apparatus generating candidate models according to some embodiments of the present disclosure.

FIG. 3 is a flow diagram illustrating a model determination apparatus selecting at least one output model according to some embodiments of the present disclosure.

FIG. 4 is a flow diagram illustrating a model determination method according to a second embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

Adversarial attack is an attack method against machine learning models, for example, for the machine learning model configured for image recognition, attackers can add noise (also known as interference) that cannot be recognized by naked eyes into images which can be correctly recognized by the model. In this case, the model may be unable to recognize or misjudge the adjusted image although the difference between the unadjusted image and the adjusted image cannot be recognized by naked eyes.

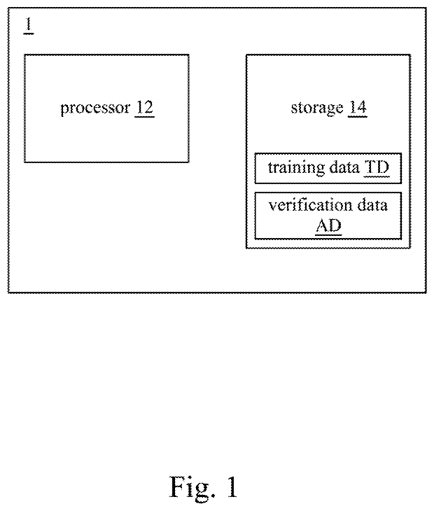

Please refer to FIG. 1. FIG. 1 is a schematic diagram illustrating a model determination apparatus 1 according to a first embodiment of the present disclosure. The model determination apparatus 1 comprises a processor 12 and a storage 14, wherein the processor 12 is coupled to the storage 14. The storage 14 is configured to store a plurality of training data TD and a plurality of validation data AD, wherein the training data TD is configured as a training set for training a machine learning model, and the validation data AD is configured as a validation set for determining the accuracy of the machine learning model.

In some embodiments, the training data TD and the validation data AD can be labeled images when the model determination apparatus 1 is configured to train an image recognition model. For example, the training data TD and the validation data AD can be images comprising transportation vehicles when the model determination apparatus 1 is configured to train an image recognition model configured for identifying types of vehicles in images (e.g., bus, bicycle, plane, etc.). Furthermore, the labels of the training data TD and the validation data AD can also comprise the scenes in the images (e.g., water, snow, highway, etc.), and the trained model is able to determine the scene in the images, or the model determination apparatus 1 can analyze the accuracy of the trained model corresponding to different scenes during model validation.

In some embodiments, the processor 12 can comprise a central processing unit (CPU), a graphics processing unit (GPU), a multi-processor, a distributed processing system, an application specific integrated circuit (ASIC), and/or a suitable processing unit.

In some embodiments, the storage 14 can comprise a semiconductor or solid-state memory, a magnetic tape, a removable computer diskette, a random-access memory (RAM), a read-only memory (ROM), a rigid magnetic disk, and/or an optical disk.

The model determination apparatus 1 is configured to train a machine learning model, especially to train a machine learning model able to resist adversarial attacks. Namely, comparing with the model before training, the recognition accuracy for adversarial attacked data of the machine learning model can be increased after trained by the model determination apparatus 1.

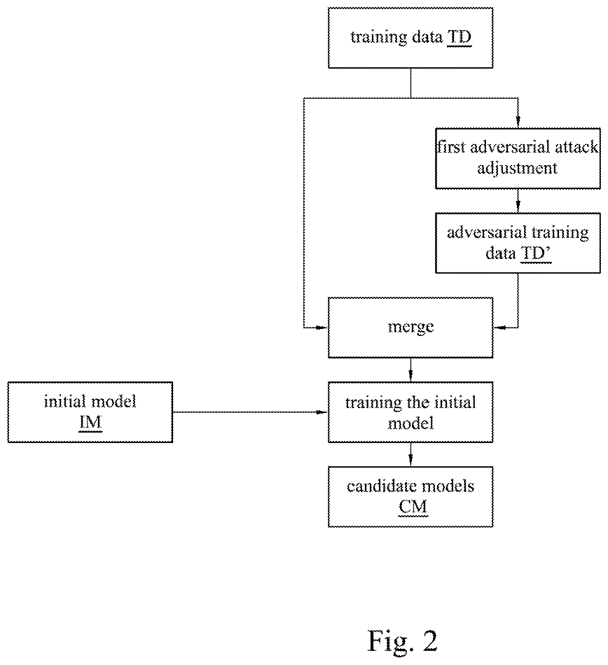

The model determination apparatus 1 is configured to generate a plurality of candidate models CM based on the training data TD. Please refer to FIG. 2. FIG. 2 is a flow diagram illustrating the model determination apparatus 1 generating candidate models CM according to some embodiments of the present disclosure.

As shown in FIG. 2, first, the processor 12 of the model determination apparatus 1 performs a first adversarial attack adjustment on the training data TD based on an initial model IM to generate a plurality of adversarial training data TD′. In some embodiments, the initial model IM is a pre-trained machine learning model, e.g., ResNet50 pre-trained model.

In some embodiments, the first adversarial attack adjustment comprises the processor 12 generating a first noise based on the initial model IM by using an adversarial attack function; and the processor 12 generating the adversarial training data TD′ based on the training data TD and the first noise. Specifically, the processor 12 can generate noise corresponding to the initial model IM by using adversarial attack algorithm (e.g., DiFGSM algorithm or TRADES algorithm) and generate the adversarial training data TD′ after adding the noise into the training data TD. Therefore, the adversarial training data TD′ is the data after adding adversarial attack noise corresponding to the initial model IM into the training data TD.

In some embodiments, the first adversarial attack adjustment further comprises the processor 12 adding the first noise into each of the training data TD to adjust the training data TD; and the processor 12 compressing the adjusted training data TD to generate the adversarial training data TD′.

Specifically, since the pixel value in the adjusted training data TD may not be an integer value and may contain noise such as decimals, the processor 12 can remove noise such as decimals in the pixel through compressing the adjusted training data TD. For example, the processor 12 can save the adjusted training data TD in jpeg format to compress the adjusted training data TD and take it as the adversarial training data TD′.

Next, as shown in FIG. 2, the processor 12 of the model determination apparatus 1 merges the training data TD and the adversarial training data TD′ and train the initial model IM by using the merged data to generate a plurality of the candidate models CM. Specifically, the processor 12 trains the candidate models CM having different parameters by using the training data TD and the adversarial training data TD′ through multiple epochs of training. Since the training data comprises the original training data TD and the adversarial training data TD′ after adversarial attack adjustment, the trained candidate models CM can not only recognize general data, but also be capable of defending adversarial attacks (i.e., being able to recognize adversarial-attacked data correctly). In some embodiments, the operation of training the initial model IM can be fine-tuning the initial model IM.

In some embodiments, the operation of training the initial model IM comprises the processor 12 training the initial model IM corresponding to a plurality of parameter sets based on the training data TD and the adversarial training data TD′ to generate the candidate models CM corresponding to the parameter sets.

Specifically, the processor 12 can take multiple different hyperparameters as the parameter sets of the initial model IM to control the parameters in every epoch of training. Accordingly, the parameters of the candidate models CM generated through every epoch of training are different despite using the same training data, and the model determination apparatus 1 can then select the model with better performance.

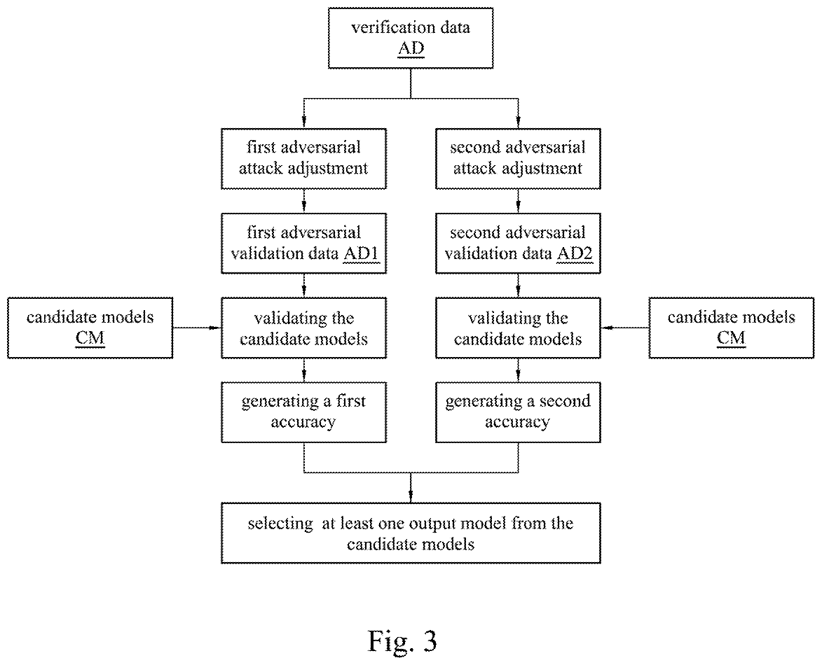

After generating multiple the candidate models CM, the model determination apparatus 1 further evaluates the recognition accuracy of the candidate models CM and selects an output model with a higher reliability from the candidate models CM accordingly. Please refer to FIG. 3 for the operations of evaluating and selecting the candidate models CM.

As shown in FIG. 3, the processor 12 of the model determination apparatus 1 performs the first adversarial attack adjustment on the validation data AD based on the initial model IM to generate a plurality of first adversarial validation data AD1. Specifically, the processor 12 can adjust the validation data AD through the same first adversarial attack adjustment mentioned above to generate the first adversarial validation data AD1 comprising adversarial attack noise corresponding to the initial model IM.

Furthermore, the processor 12 can validate the candidate models CM by using the first adversarial validation data AD1 to generate a first accuracy. Specifically, the processor 12 compares the recognition results of each of the candidate models CM recognizing the first adversarial validation data AD1 and the labels of the first adversarial validation data AD1 to calculate the first accuracy of each of the candidate models CM recognizing the first adversarial validation data AD1.

On the other hand, the processor 12 of the model determination apparatus 1 also performs a second adversarial attack adjustment on the validation data AD based on the candidate models CM to generate a plurality of second adversarial validation data AD2.

In some embodiments, the second adversarial attack adjustment comprises the processor 12 generating a second noise based on one of the candidate models CM by using an adversarial attack function; and the processor 12 generating the second adversarial validation data based on the validation data and the second noise.

Specifically, different from the first adversarial attack adjustment, the second adversarial attack adjustment is the processor 12 generate noise corresponding to one of the candidate models CM needed to be evaluated by using adversarial attack algorithm (e.g., DiFGSM algorithm or TRADES algorithm) and generate the second adversarial validation data AD2 after adding the noise into the validation data AD. Therefore, the second adversarial validation data AD2 is the data after adding adversarial attack noise corresponding to one of the candidate models CM into the validation data AD.

It is noticed that, in order to simulate the actual scenario of being adversarial attacked, in some embodiments, the processor 12 will not compress the second adversarial validation data AD2. In other words, the second noise can be completely reserved after the processor 12 generates the second adversarial validation data AD2 to execute the subsequent validation operations.

Furthermore, the processor 12 can validate the candidate models CM by using the second adversarial validation data AD2 to generate the second accuracy. Specifically, the processor 12 compares the recognition results of each of the candidate models CM recognizing the second adversarial validation data AD2 and the labels of the second adversarial validation data AD2 to calculate the second accuracy of each of the candidate models CM recognizing the second adversarial validation data AD2.

Finally, the processor 12 can evaluate the defense capability against adversarial attacks of each of the candidate models CM based on the first accuracy and the second accuracy, wherein the first accuracy represents the defense capability against the adversarial attack on the initial model IM of each of the candidate models CM. The higher the first accuracy, the higher the defense capability. The second accuracy represents the defense capability against the adversarial attack on each of the candidate models CM itself. The higher the second accuracy, the higher the defense capability.

In some embodiments, the processor 12 of the model determination apparatus 1 can sort the candidate models CM based on the first accuracy and the second accuracy of each of the candidate models CM and select at least one of the candidate models CM with the highest first accuracy and/or the highest second accuracy as the output model.

In summary, the model determination apparatus 1 provided by the present disclosure can train the candidate models CM by using general training data and adversarial-attacked training data. Furthermore, the model determination apparatus 1 can also evaluate the defense capability against different adversarial attacks of the candidate models CM by using the first adversarial validation data AD1 adversarial-attack adjusted based on the untrained initial model IM and the second adversarial validation data AD2 adversarial-attack adjusted based on the candidate models CM itself, thereby selecting at least one of the candidate models CM with better defense capability. In this case, through the operation of training models and evaluating the defense capability against different adversarial attacks by the model determination apparatus 1, the output model generated by the model determination apparatus 1 can ensure the recognition accuracy of both general data and adversarial-attack adjusted data without sacrificing the recognition accuracy of general data while increasing the defense capability against adversarial attacks.

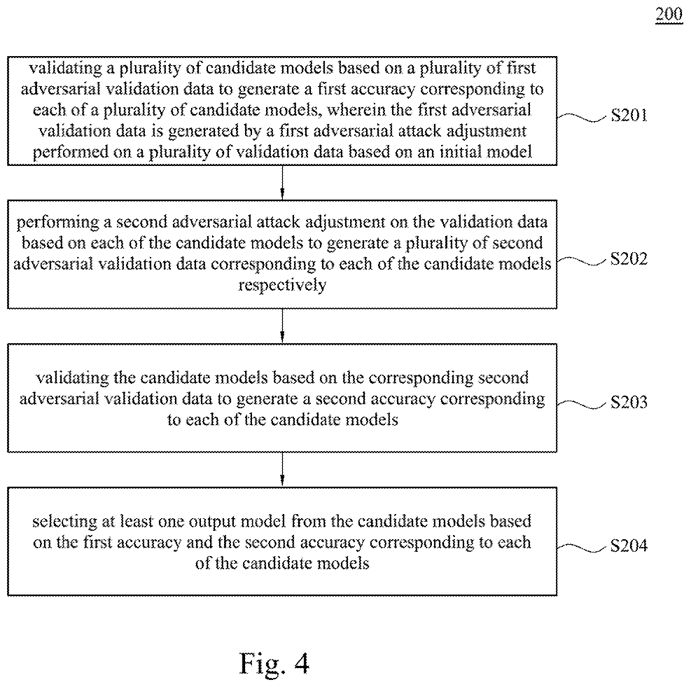

Please refer to FIG. 4. FIG. 4 is a flow diagram illustrating a model determination method 200 according to a second embodiment of the present disclosure. The model determination method 200 comprises steps S201-S206.

The model determination method 200 is configured to train a machine learning model, especially to train a machine learning model able to resist adversarial attacks. Namely, comparing with the model before training, the recognition accuracy for adversarial attacked data of the machine learning model can be increased after trained by the model determination method 200. The model determination method 200 can be executed by a processor (e.g., the processor 12 shown in FIG. 1).

In the step S201, the processor validates a plurality of candidate models based on a plurality of first adversarial validation data to generate a first accuracy corresponding to each of the candidate models, wherein the first adversarial validation data is generated by a first adversarial attack adjustment performed on the validation data based on an initial model.

In the step S202, the processor performs a second adversarial attack adjustment on the validation data based on each of the candidate models to generate a plurality of second adversarial validation data corresponding to each of the candidate models respectively.

In the step S203, the processor validates the candidate models based on the corresponding second adversarial validation data to generate a second accuracy corresponding to each of the candidate models.

In the step S204, the processor selects at least one output model from the candidate models based on the first accuracy and the second accuracy corresponding to each of the candidate models.

In some embodiments, the candidate models are generated through the following steps: performing the first adversarial attack adjustment on a plurality of training data based on the initial model to generate a plurality of adversarial training data; and training the initial model based on the training data and the adversarial training data to generate the candidate models.

In some embodiments, the step of training the initial model further comprising: training the initial model corresponding to a plurality of parameter sets based on the training data and the adversarial training data to generate the candidate models corresponding to the parameter sets.

In some embodiments, each of the candidate models corresponds to a different one of the parameter sets.

In some embodiments, the first adversarial attack adjustment comprises the following steps: generating a first noise based on the initial model by using an adversarial attack function; and generating the first adversarial validation data based on the validation data and the first noise.

In some embodiments, the first adversarial attack adjustment comprises the following step: adding the first noise into each of the validation data to adjust the validation data.

In some embodiments, the first adversarial attack adjustment comprises the following step: compressing the adjusted validation data to generate the first adversarial validation data.

In some embodiments, the second adversarial attack adjustment comprises the following steps: generating a second noise based on one of the candidate models by using an adversarial attack function; and generating the second adversarial validation data based on the validation data and the second noise.

In some embodiments, the step of selecting the at least one output model further comprising: selecting a first candidate model having a highest first accuracy and a second candidate model having a highest second accuracy as the at least one output model from the candidate models.

In some embodiments, the initial model is a pre-trained machine learning model.

In summary, the model determination method 200 provided by the present disclosure can train the candidate models by using general training data and adversarial-attacked training data. Furthermore, the model determination method 200 can also evaluate the defense capability against different adversarial attacks of the candidate models by using the first adversarial validation data adversarial-attack adjusted based on the untrained initial model IM and the second adversarial validation data adversarial-attack adjusted based on the candidate models itself, thereby selecting at least one of the candidate models with better defense capability. In this case, through the operation of training models and evaluating the defense capability against different adversarial attacks by the model determination method 200, the output model generated by the model determination method 200 can ensure the recognition accuracy of both general data and adversarial-attack adjusted data without sacrificing the recognition accuracy of general data while increasing the defense capability against adversarial attacks.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A model determination apparatus, comprising:
a storage, configured to store a plurality of training data and a plurality of validation data; and
a processor, coupled to the storage, configured to execute the following operations:
validating a plurality of candidate models based on a plurality of first adversarial validation data to generate a first accuracy corresponding to each of the candidate models, wherein the first adversarial validation data is generated by a first adversarial attack adjustment performed on the validation data based on an initial model;
performing a second adversarial attack adjustment on the validation data based on each of the candidate models to generate a plurality of second adversarial validation data corresponding to each of the candidate models respectively;
validating the candidate models based on the corresponding second adversarial validation data to generate a second accuracy corresponding to each of the candidate models; and
selecting at least one output model from the candidate models based on the first accuracy and the second accuracy corresponding to each of the candidate models.

2. The model determination apparatus of claim 1, wherein the candidate models are generated through the following operations:
performing the first adversarial attack adjustment on the training data based on the initial model to generate a plurality of adversarial training data; and
training the initial model based on the training data and the adversarial training data to generate the candidate models.

3. The model determination apparatus of claim 2, wherein the operation of training the initial model further comprising:
training the initial model corresponding to a plurality of parameter sets based on the training data and the adversarial training data to generate the candidate models corresponding to the parameter sets.

4. The model determination apparatus of claim 3, wherein each of the candidate models corresponds to a different one of the parameter sets.

5. The model determination apparatus of claim 1, wherein the first adversarial attack adjustment comprises the following operations:
generating a first noise based on the initial model by using an adversarial attack function; and
generating the first adversarial validation data based on the validation data and the first noise.

6. The model determination apparatus of claim 5, wherein the first adversarial attack adjustment comprises the following operation:
adding the first noise into each of the validation data to adjust the validation data.

7. The model determination apparatus of claim 6, wherein the first adversarial attack adjustment comprises the following operation:
compressing the adjusted validation data to generate the first adversarial validation data.

8. The model determination apparatus of claim 1, wherein the second adversarial attack adjustment comprises the following operations:
generating a second noise based on one of the candidate models by using an adversarial attack function; and
generating the second adversarial validation data based on the validation data and the second noise.

9. The model determination apparatus of claim 1, wherein the operation of selecting the at least one output model further comprising:
selecting a first candidate model having a highest first accuracy and a second candidate model having a highest second accuracy as the at least one output model from the candidate models.

10. The model determination apparatus of claim 1, wherein the initial model is a pre-trained machine learning model.

11. A model determination method, being adapted for use in a processor, comprising:
validating a plurality of candidate models based on a plurality of first adversarial validation data to generate a first accuracy corresponding to each of a plurality of candidate models, wherein the first adversarial validation data is generated by a first adversarial attack adjustment performed on a plurality of validation data based on an initial model;
performing a second adversarial attack adjustment on the validation data based on each of the candidate models to generate a plurality of second adversarial validation data corresponding to each of the candidate models respectively;
validating the candidate models based on the corresponding second adversarial validation data to generate a second accuracy corresponding to each of the candidate models; and
selecting at least one output model from the candidate models based on the first accuracy and the second accuracy corresponding to each of the candidate models.

12. The model determination method of claim 11, wherein the candidate models are generated through the following steps:
performing the first adversarial attack adjustment on a plurality of training data based on the initial model to generate a plurality of adversarial training data; and
training the initial model based on the training data and the adversarial training data to generate the candidate models.

13. The model determination method of claim 12, wherein the step of training the initial model further comprising:
training the initial model corresponding to a plurality of parameter sets based on the training data and the adversarial training data to generate the candidate models corresponding to the parameter sets.

14. The model determination method of claim 13, wherein each of the candidate models corresponds to a different one of the parameter sets.

15. The model determination method of claim 11, wherein the first adversarial attack adjustment comprises the following steps:
generating a first noise based on the initial model by using an adversarial attack function; and
generating the first adversarial validation data based on the validation data and the first noise.

16. The model determination method of claim 15, wherein the first adversarial attack adjustment comprises the following step:
adding the first noise into each of the validation data to adjust the validation data.

17. The model determination method of claim 16, wherein the first adversarial attack adjustment comprises the following step:
compressing the adjusted validation data to generate the first adversarial validation data.

18. The model determination method of claim 11, wherein the second adversarial attack adjustment comprises the following steps:
generating a second noise based on one of the candidate models by using an adversarial attack function; and
generating the second adversarial validation data based on the validation data and the second noise.

19. The model determination method of claim 11, wherein the step of selecting the at least one output model further comprising:
selecting a first candidate model having a highest first accuracy and a second candidate model having a highest second accuracy as the at least one output model from the candidate models.

20. The model determination method of claim 11, wherein the initial model is a pre-trained machine learning model.
